(19) United States
(12) Patent Application Publication
(10) Pub. No.: US 2024/0233190 A1
(43) Pub. Date: Jul. 11, 2024

(54) PARTIAL DECODING AND RECONSTRUCTION OF SUBMESHES

(71) Applicant: Samsung Electronics Co., Ltd., Suwon-si (KR)

(72) Inventors: Rajan Laxman Joshi, San Diego, CA (US); Youngkwon Lim, Allen, TX (US); Madhukar Budagavi, Plano, TX (US)

(21) Appl. No.: 18/399,529

(22) Filed: Dec. 28, 2023

Related U.S. Application Data
(60) Provisional application No. 63/438,198, filed on Jan. 10, 2023.
(60) Provisional application No. 63/438,417, filed on Jan. 11, 2023.
(60) Provisional application No. 63/439,456, filed on Jan. 17, 2023.

(51) Int. Cl. G06T 9/00

(52) U.S. Cl. CPC G06T 9/001

(57) ABSTRACT

An apparatus includes a communication interface configured to receive a compressed bitstream having sub-bitstreams including a base mesh sub-bitstream, a displacement sub-bitstream, and an attributes sub-bitstream. The apparatus also includes a processor operably coupled to the communication interface. The processor is configured to decode at least a portion of the compressed bitstream, wherein the processor is configured to decode a plurality of submeshes from the base mesh sub-bitstream, decode geometry data from the displacement sub-bitstream, and decode attributes data from the attributes sub-bitstream. The processor is also configured to subdivide a submesh of the plurality of submeshes to generate a subdivided submesh. The processor is also configured to reconstruct vertex positions, using the decoded geometry data, and attributes, using the decoded attributes data, of the subdivided submesh independently of decoded data corresponding to one or more other submeshes.

### CROSS-REFERENCE TO RELATED APPLICATION AND PRIORITY CLAIM

This application claims priority under 35 U.S.C. § 119(e) to U.S. Provisional Patent Application No. 63/438,198 filed on Jan. 10, 2023, U.S. Provisional Patent Application No. 63/438,417 filed on Jan. 11, 2023, and U.S. Provisional Patent Application No. 63/439,456 filed on Jan. 17, 2023, which are hereby incorporated by reference in their entirety.

### TECHNICAL FIELD

This disclosure relates generally to multimedia devices and processes. More specifically, this disclosure relates to partial decoding and reconstruction of submeshes.

### BACKGROUND

Three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

### SUMMARY

This disclosure provides for partial decoding and reconstruction of submeshes.

In a first embodiment, an apparatus includes a communication interface configured to receive a compressed bitstream having sub-bitstreams including a base mesh sub-bitstream, a displacement sub-bitstream, and an attributes sub-bitstream. The apparatus also includes a processor operably coupled to the communication interface. The processor is configured to decode at least a portion of the compressed bitstream, wherein the processor is configured to decode a plurality of submeshes from the base mesh sub-bitstream, decode geometry data from the displacement sub-bitstream, and decode attributes data from the attributes sub-bitstream. The processor is also configured to subdivide a submesh of the plurality of submeshes to generate a subdivided submesh. The processor is also configured to reconstruct vertex positions, using the decoded geometry data, and attributes, using the decoded attributes data, of the subdivided submesh independently of decoded data corresponding to one or more other submeshes. The processor is also configured to reconstruct at least a portion of a mesh-frame using the reconstructed vertex positions and reconstructed attributes corresponding to the subdivided submesh.

In a second embodiment, a method includes receiving a compressed bitstream having sub-bitstreams including a base mesh sub-bitstream, a displacement sub-bitstream, and an attributes sub-bitstream. The method also includes decoding at least a portion of the compressed bitstream, including decoding a plurality of submeshes from the base mesh sub-bitstream, decoding geometry data from the displacement sub-bitstream, and decoding attributes data from the attributes sub-bitstream. The method also includes subdividing a submesh of the plurality of submeshes to generate a subdivided submesh. The method also includes reconstructing vertex positions, using the decoded geometry data, and attributes, using the decoded attributes data, of the subdivided submesh independently of decoded data corresponding to one or more other submeshes. The method also includes reconstructing at least a portion of a mesh-frame using the reconstructed vertex positions and reconstructed attributes corresponding to the subdivided submesh.

In a third embodiment, an apparatus includes a communication interface and a processor operably coupled to the communication interface. The processor is configured to encode geometry data and attributes data associated with an individual submesh into a displacement sub-bitstream and an attributes sub-bitstream, respectively. The geometry data and attributes data associated with the individual submesh are capable of being separated from data corresponding to one or more other submeshes in the displacement sub-bitstream and the attributes sub-bitstream during decoding. The processor is also configured to combine the displacement sub-bitstream and the attributes sub-bitstream into a compressed bitstream.

In a fourth embodiment, a method includes encoding geometry data and attributes data associated with an individual submesh into a displacement sub-bitstream and an attributes sub-bitstream, respectively. The geometry data and attributes data associated with the individual submesh are capable of being separated from data corresponding to one or more other submeshes in the displacement sub-bitstream and the attributes sub-bitstream during decoding. The method also includes combining the displacement sub-bitstream and the attributes sub-bitstream into a compressed bitstream.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIGS. 2 and 3 illustrate example electronic devices in accordance with this disclosure;

FIG. 4 illustrates an example intra-frame encoding process in accordance with this disclosure;

FIG. 5 illustrates an example mesh frame decoding process in accordance with this disclosure;

FIG. 6 illustrates an example process for bitstream conformance for partial reconstruction and/or decoding of submeshes in accordance with this disclosure;

FIG. 7 illustrates an example process for bounding coordinates associated with a sub-bitstream in accordance with this disclosure;

FIG. 8 illustrates an example process for bounding coordinates associated with a sub-bitstream in a non-overlapping manner in accordance with this disclosure;

FIG. 9 illustrates an example encoding method for partial reconstruction and/or decoding of submeshes in accordance with this disclosure; and

FIG. 10 illustrates an example decoding method for partial reconstruction and/or decoding of submeshes in accordance with this disclosure.

### DETAILED DESCRIPTION

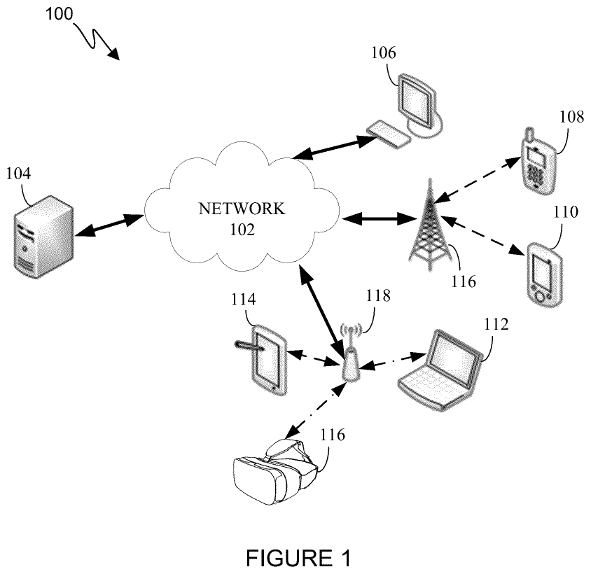

FIGS. 1 through 10, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, three hundred sixty degree(360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

A point cloud is a set of 3D points along with attributes such as color, normal directions, reflectivity, point-size, etc. that represent an object's surface or volume. Point clouds are common in a variety of applications such as gaming, 3D maps, visualizations, medical applications, augmented reality, virtual reality, autonomous driving, multi-view replay, and six degrees of freedom (DoF) immersive media, to name a few. Point clouds, if uncompressed, generally require a large amount of bandwidth for transmission. Due to the large bitrate requirement, point clouds are often compressed prior to transmission. Compressing a 3D object such as a point cloud, often requires specialized hardware. To avoid specialized hardware to compress a 3D point cloud, a 3D point cloud can be transformed into traditional two-dimensional (2D) frames and that can be compressed and later reconstructed and viewable to a user.

Polygonal 3D meshes, especially triangular meshes, are another popular format for representing 3D objects. Meshes typically consist of a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively. Since point clouds and meshes contain a large amount of data, they require compression for efficient storage and transmission. This is particularly true for dynamic point clouds and meshes, which may contain 60 frames or higher per second.

As part of an encoding process, a base mesh can be coded using an existing mesh codec, and a reconstructed base mesh can be constructed from the coded original mesh. The reconstructed base mesh can then be subdivided into one or more subdivided meshes and a displacement field is created for each subdivided mesh. For example, if the reconstructed base mesh includes triangles covering the surface of the 3D object, the triangles are subdivided according to a number of subdivision levels, such as to create a first subdivided mesh in which each triangle of the reconstructed base mesh is subdivided into four triangles, a second subdivided mesh in which each triangle of the reconstructed base mesh is subdivided into sixteen triangles, and so on, depending on how many subdivision levels are applied. Each displacement field represents the difference between vertex positions of the original mesh and the subdivided mesh associated with the displacement field. Each displacement field is wavelet transformed to create level of detail (LOD) signals that are encoded as part of a compressed bitstream. During decoding, the displacements of each displacement field are added to their associated subdivided mesh to reconstruct a version of the original mesh.

Typically, mesh encoding and decoding operations are highly sequential. For base meshes with a large number of vertices and high frame rates, a mesh codec may have difficulty achieving real-time encoding and decoding. To alleviate this problem, submeshes are used. A base mesh may be divided into multiple submeshes. The submeshes may not be mutually exclusive, that is, some vertices and triangles may be common to different submeshes. It is possible that the submeshes can be encoded and decoded without using any information from other submeshes. This allows multiple instances of a mesh codec to operate in parallel on different submeshes. This also enables functionality to perform partial decoding of the mesh by decoding only some of the submeshes present in a bitstream. Each decoded submesh may undergo subdivision and then the decoded displacement field is used to refine the position of the subdivided points belonging to that submesh.

The creation of submeshes, however, is not sufficient to ensure the functionality of partial decoding and reconstruction of the full resolution mesh. For example, if the displacement video and the attribute video is not tiled, partial decoding is not possible for those videos. Also, typically a wavelet transform is applied to the displacement field on the encoder side and a corresponding inverse wavelet transform is applied on the decoder side. If the forward wavelet transform uses vertices corresponding to a different submesh, partial reconstruction of vertices corresponding to a submesh may not be possible on the decoder side unless the relevant wavelet coefficients corresponding to other submeshes that are needed by the inverse wavelet transform have been decoded. In some cases, additionally, inverse wavelet transform may be performed on relevant wavelet coefficients corresponding to other submeshes.

This disclosure provides for partial reconstruction and/or partial decoding of bitstreams when multiple submeshes are used. Various embodiments of this disclosure include bitstream conformance restrictions on bitstreams and syntax elements to facilitate partial decoding and/or reconstruction of vertices and corresponding attributes for the submeshes. As further described in this disclosure, in some embodiments, a bitstream conformance can be imposed that requires that it shall be possible to reconstruct vertices, vertices connectivity, and attribute data corresponding to a submesh independently of the decoded data corresponding to other submeshes. As further described in this disclosure, in some embodiments, a bitstream conformance can be imposed that requires that it shall be possible to decode and reconstruct vertices, connectivity, and attribute data corresponding to a submesh independently of other submeshes.

In some instance in this disclosure, the term “submesh” can refers to the partitioning of the base mesh. In some instances, in this disclosure, “submesh” can mean the geometric data that is reconstructed after the submesh is subdivided and displacements added.

FIG. 1 illustrates an example communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder. In certain embodiments, the server 104 can perform partial decoding and/or partial reconstruction of submeshes as described in this disclosure.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can compress a 3D point cloud or mesh to generate a bitstream and then transmit the bitstream to one or more of the client devices 106-116. As another example, one of the client devices 106-116 can compress a 3D point cloud or mesh to generate a bitstream and then transmit the bitstream to another one of the client devices 106-116 or to the server 104. In accordance with this disclosure, the server 104 and/or the client devices 106-116 can perform partial decoding and/or partial reconstruction of submeshes as described in this disclosure.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

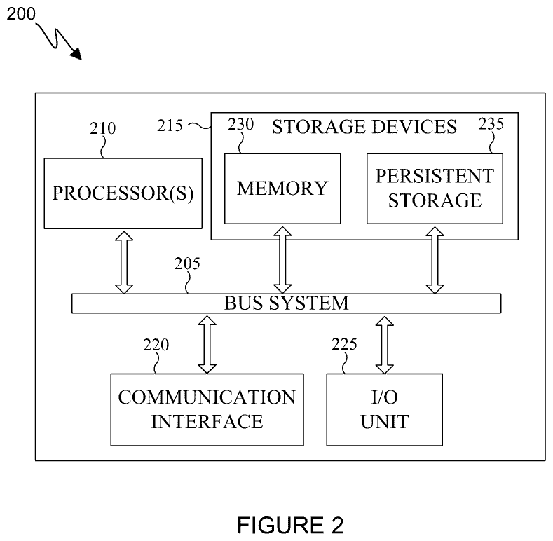

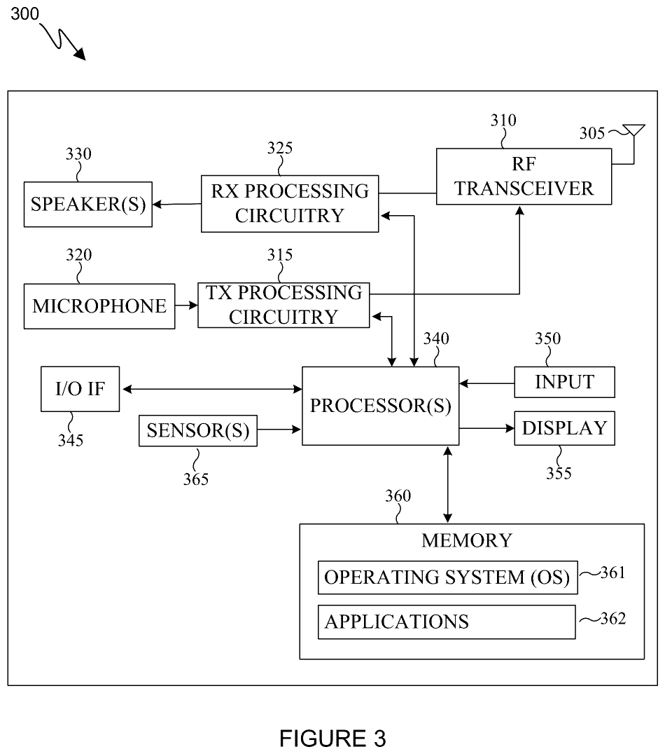

FIGS. 2 and 3 illustrate example electronic devices in accordance with this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding. In certain embodiments, the processor 210 can perform partial decoding and/or partial reconstruction of submeshes as described in this disclosure.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content. In certain embodiments, the processor 340 can perform partial decoding and/or partial reconstruction of submeshes as described in this disclosure.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

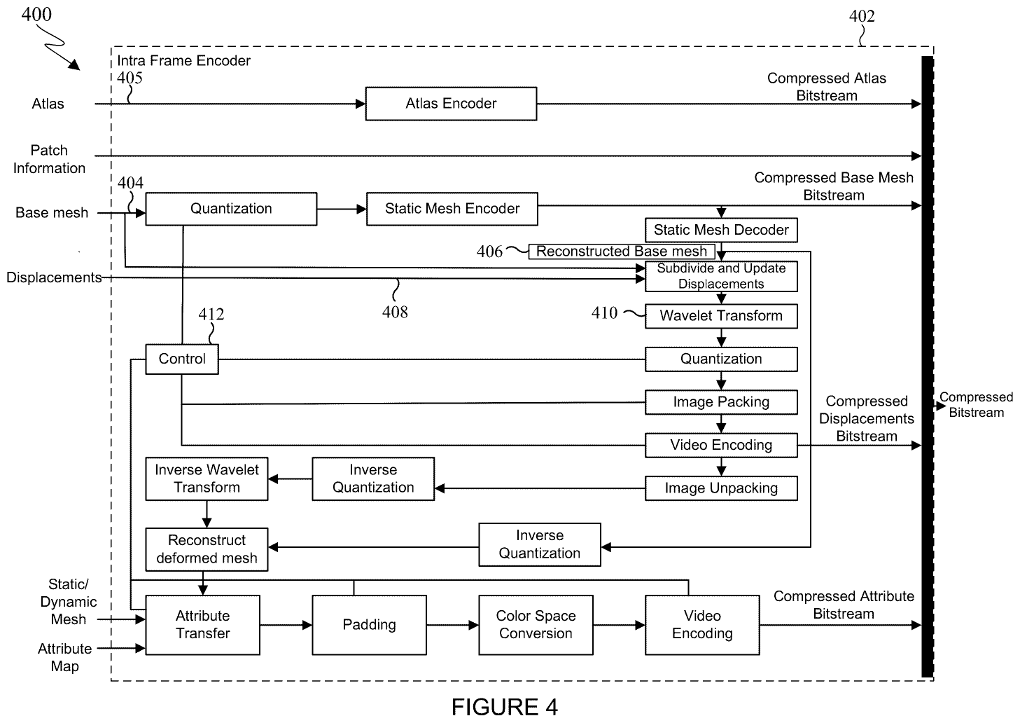

FIG. 4 illustrates an example intra-frame encoding process 400 in accordance with this disclosure. The intra-frame encoding process 400 illustrated in FIG. 4 is for illustration only. FIG. 4 does not limit the scope of this disclosure to any particular implementation of an intra-frame encoding process. For ease of explanation, the process 400 of FIG. 4 may be described as being performed using the electronic device 300 of FIG. 3. However, the process 400 may be used with any other suitable system and any other suitable electronic device.

As shown in FIG. 4, the intra-frame encoding process 400 encodes a mesh frame using an intra-frame encoder 402. The intra-frame encoder 402 can be represented by, or executed by, the server 200 shown in FIG. 2 or the electronic device 300 shown in FIG. 3. A base mesh 404, which typically has a smaller number of vertices compared to the original mesh, is created and is quantized and compressed in either a lossy or lossless manner, and then encoded as a compressed base mesh bitstream. As shown in FIG. 4, a static mesh decoder decodes and reconstructs the base mesh, providing a reconstructed base mesh 406. This reconstructed base mesh 406 then undergoes one or more levels of subdivision and a displacement field is created for each subdivision representing the difference between the original mesh and the subdivided reconstructed base mesh. In inter-coding of a mesh frame, the base mesh 404 is coded by sending vertex motions instead of compressing the base mesh directly. In either case, a displacement field 408 is created. Each displacement of the displacement field 408 has three components, denoted by x, y, and z. These may be with respect to a canonical coordinate system or a local coordinate system where x, y, and z represent the displacement in local normal, tangent, and bi-tangent directions. It will be understood that multiple levels of subdivision can be applied, such that multiple subdivided mesh frames are created and a displacement field for each subdivided mesh frame is also created.

Let the number of 3-D displacement vectors in a displacement 408 of a mesh-frame be N. Let the displacement field be denoted by d(i)=[dₓ(i), d_{y}(i), d_{z}(i)], 0≤i<N. The displacement fields 408 undergo one or more levels of wavelet transformation 410 to create level of detail (LOD) signals d^{k}(i), i=0≤i<N^{k}, 0≤k<numLOD, where k denotes the index of the level of detail, N^{k} denotes the number of samples in the level of detail signal at level k, and numLOD denotes the number of LODs. The LOD signals d^{k} (i) are scalar quantized.

As shown in FIG. 4, the quantized LOD signals corresponding to the displacement fields 408 are coded into a compressed bitstream. In various embodiments, the quantized LOD signals are packed into a 2D image/video using an image packing operation, and are compressed losslessly or in a lossy manner by using an image or video encoder. However, it is possible to use another entropy coder such as an asymmetric numeral systems (ANS) coder or a binary arithmetic entropy coder to code the quantized LOD signals losslessly. There may be other dependencies based on previous samples, across components, and across LODs that may be exploited. The displacements component provides displacement vectors that can be encoded as a geometry video component using any video codec, indicated by the profile or using an SEI message. Alternatively, the profile may indicate that the displacement component is encoded using arithmetic coding.

As also shown in FIG. 4, image unpacking of the LOD signals is performed and an inverse quantization operation and an inverse wavelet transform operation are performed to reconstruct the LOD signals. Another inverse quantization operation is performed on the reconstructed base mesh 406, which is combined with the reconstructed LOD signals to reconstruct a deformed mesh. An attribute transfer operation is performed using the deformed mesh, a static/dynamic mesh, and an attribute map. A point cloud is a set of 3D points along with attributes such as color, normals, reflectivity, point-size, etc. that represent an object's surface or volume. These attributes are encoded as a compressed attribute bitstream. As shown in FIG. 4, the encoding of the compressed attribute bitstream may also include a padding operation, a color space conversion operation, and a video encoding operation. In various embodiments, an atlas 405 can also be encoded as a compressed atlas bitstream. The atlas component provides information to a decoding and/or rendering system on how to perform inverse reconstruction. For example, the atlas can provide information on how to perform the subdivision of a base mesh, how to apply the displacement vectors to the subdivided mesh vertices, and how to apply attributes to the reconstructed mesh.

The various functions or operations shown in FIG. 4 can be controlled by a control process 412. The intra-frame encoding process 400 outputs the compressed bitstream that can, for example, be transmitted to, and decoded by, an electronic device such as the server 104 or the client devices 106-116. As shown in FIG. 4, the output compressed bitstream can include the compressed atlas bitstream, the compressed base mesh bitstream, the compressed displacements bitstream, and the compressed attribute bitstream as sub-bitstreams of the compressed bitstream.

Although FIG. 4 illustrates one example intra-frame encoding process 400, various changes may be made to FIG. 4. For example, the number and placement of various components of the intra-frame encoding process 400 can vary as needed or desired. In addition, the intra-frame encoding process 400 may be used in any other suitable process and is not limited to the specific processes described above. In certain embodiments, only the first (x) component of the displacement may be created and coded, and the other two components (y and z) may be assumed to be 0. In such a case, a flag may be signaled in the bitstream to indicate that the bitstream contains only data corresponding to the first (x) component and the other two components (y and z) should be assumed to be zero when decompressing and reconstructing the displacement field 408. As another example, the intra-frame encoding process 400 of FIG. 4 can include encoding the bitstream and/or implementing appropriate signaling to allow decoder to perform partial reconstruction and/or partial decoding of submeshes, as described in this disclosure.

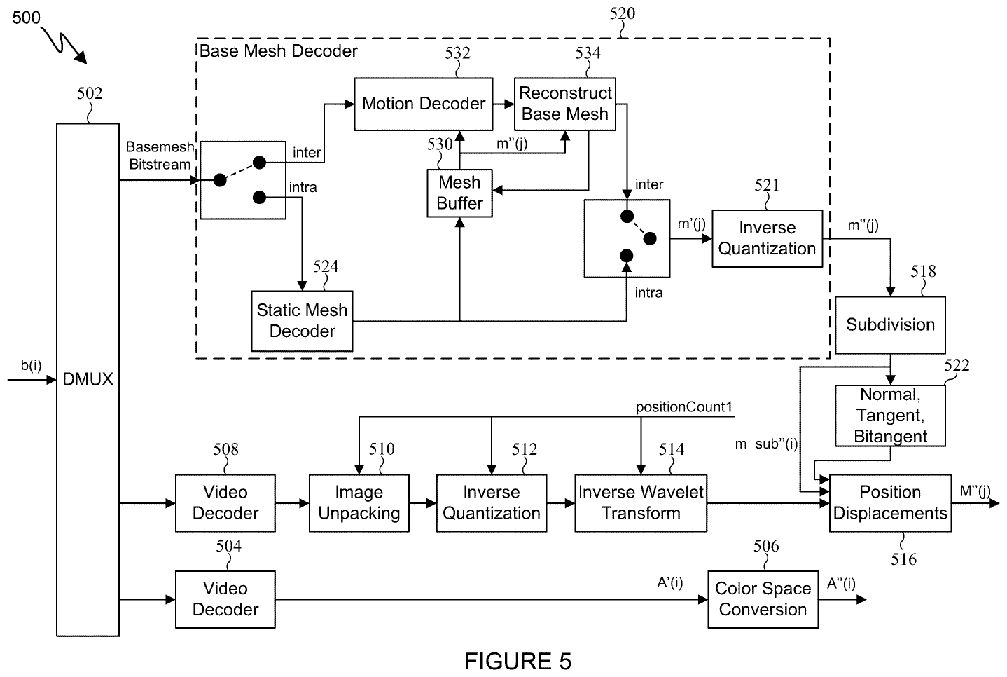

FIG. 5 illustrates an example mesh frame decoding process 500 in accordance with this disclosure. The frame decoding process 500 illustrated in FIG. 5 is for illustration only. FIG. 5 does not limit the scope of this disclosure to any particular implementation of a mesh frame decoding process. For ease of explanation, the process 500 of FIG. 5 may be described as being performed using the electronic device 300 of FIG. 3. However, the process 500 may be used with any other suitable system and any other suitable electronic device.

The decoding process 500 involves a demultiplexer 502 that receives an incoming bitstream. The demultiplexer separates out the various component bitstreams from the incoming bitstream, including the compressed base mesh bitstream, the compressed displacements bitstream, and the compressed attribute bitstream, such as described with respect to FIG. 4. The compressed attribute bitstream is decoded using a video decoder 504, the decoded attributes are processed using a color space conversion operation 506, and the original attributes for the mesh are recovered.

The decoding process 500 also includes decoding the displacements bitstream using a video decoder 508, which can, in some embodiments, be the same video decoder as the video decoder 504. The decoded displacements data undergoes an image unpacking operation 510, an inverse quantization operation 512, and an inverse wavelet transform operation 514, as part of recovering the positions displacements data 516. Recovering the positions displacements data 516 can also include performing one or more subdivision operations 518 on the mesh frame recovered using a base mesh decoder 520, and extracting x, y, z components 522 (normal, tangent, bitangent) from the subdivided mesh frames. The base mesh decoder 520 can perform an inverse quantization operation 521 before the subdivision operation 518 is performed.

The base mesh decoder 520 takes the base mesh bitstream provided by the demultiplexer 502 and reconstructs, from the base mesh bitstream, intra base mesh frames using a static mesh decoder 524. A mesh buffer 530 provides the decoded intra frames to a motion decoder 532. The motion decoder 532 also receives inter frame data and uses the intra frame data, inter frame data, and associated tables to reconstruct a base mesh at step 534.

Although FIG. 5 illustrates one example frame decoding process 500, various changes may be made to FIG. 5. For example, the number and placement of various components of the frame decoding process 500 can vary as needed or desired. In addition, the frame decoding process 500 may be used in any other suitable process and is not limited to the specific processes described above. Also, while shown as a series of steps, various steps in FIG. 5 may overlap, occur in parallel, or occur any number of times. Additionally, as described with respect to FIG. 4, an atlas bitstream can also be decoded to obtain an atlas that provides information on how to perform inverse reconstruction. For example, the atlas can provide information on how to perform the subdivision of a base mesh, how to apply the displacement vectors to the subdivided mesh vertices, and how to apply attributes to the reconstructed mesh.

As described herein, typically, mesh encoding and decoding operations are highly sequential. For base meshes with a large number of vertices and high frame rates, a mesh codec may have difficulty achieving real-time encoding and decoding. To alleviate this problem, submeshes are used. A base mesh may be divided into multiple submeshes. The submeshes may not be mutually exclusive, that is, some vertices and triangles may be common to different submeshes. It is possible that the submeshes can be encoded and decoded without using any information from other submeshes. This allows multiple instances of a mesh codec to operate in parallel on different submeshes. This also enables functionality to perform partial decoding of the mesh by decoding only some of the submeshes present in a bitstream. Each decoded submesh may undergo subdivision and then the decoded displacement field is used to refine the position of the subdivided points belonging to that submesh.

The creation of submeshes, however, is not sufficient to ensure the functionality of partial decoding and reconstruction of the full resolution mesh. For example, if the displacement video and the attribute video is not tiled, partial decoding is not possible for those videos. Also, typically a wavelet transform is applied to the displacement field on the encoder side and a corresponding inverse wavelet transform is applied on the decoder side. If the forward wavelet transform uses vertices corresponding to a different submesh, partial reconstruction of vertices corresponding to a submesh may not be possible on the decoder side unless the relevant wavelet coefficients corresponding to other submeshes that are needed by the inverse wavelet transform have been decoded. In some cases, additionally, inverse wavelet transform may be performed on relevant wavelet coefficients corresponding to other submeshes.

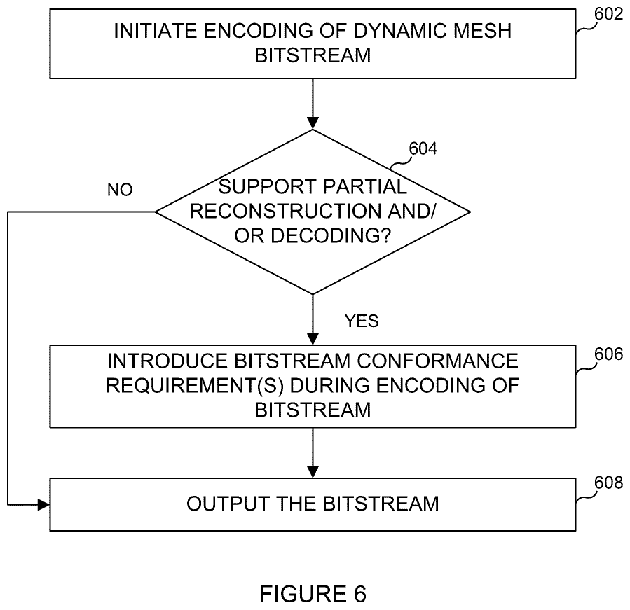

FIG. 6 illustrates an example process 600 for bitstream conformance for partial reconstruction and/or decoding of submeshes in accordance with this disclosure. The process 600 illustrated in FIG. 6 is for illustration only. FIG. 6 does not limit the scope of this disclosure to any particular implementation of a process for bitstream conformance for partial reconstruction and/or decoding of submeshes. For ease of explanation, the process 600 of FIG. 6 may be described as being performed using the electronic device 300 of FIG. 3. However, the process 600 may be used with any other suitable system and any other suitable electronic device.

As shown in FIG. 6, at step 602, the electronic device 300 initiates encoding of a dynamic mesh bitstream, such as described with respect to FIG. 4. At step 604, it is determined whether partial reconstructions and/or partial decoding of the bitstream is to be supported. If not, the process 600 moves on to step 608 to finish encoding and outputting the bitstream. If, however, at step 604, it is determined that partial reconstructions and/or partial decoding of the bitstream is to be supported, the process 600 moves to step 606. At step 606, one or more bitstream conformance requirements are introduced during encoding of the bitstream that can be recognized by a decoder due to various syntax or signaling elements to facilitate partial reconstruction and/or decoding of data including vertices, connectivity, and corresponding attributes for the submeshes. In one embodiment, all the compressed bitstreams that conform to a particular dynamic mesh coding standard such as V-DMC or its profile automatically satisfy the conformance condition without any additional syntax or signaling elements. At step 608, the electronic device 300 finishes encoding the bitstream and outputs the bitstream.

For example, in some embodiments, a bitstream conformance can be imposed that requires that it shall be possible to reconstruct vertices, connectivity, and attributes corresponding to a submesh independently of the decoded data corresponding to other submeshes. This condition requires that the decoded data corresponding to different submeshes can be separated so that individual subdivided submeshes can be reconstructed independently. This may impose certain conditions on how the bitstream is generated. For example, if the displacement field undergoes wavelet transform, e.g., wavelet transform 410, geometry data including displacements from other submeshes are excluded when the forward wavelet transform is applied. That is, the forward wavelet transform is applied independently to each submesh. It will be understood that this condition does not mandate that all the compressed data corresponding to a submesh can be decoded independently. That is, this condition allows for subdivided submeshes to be reconstructed independently after data is decoded, but not necessarily that the data can be decoded independently. Mandating that all compressed data corresponding to a submesh can be decoded independently would be a stronger condition and may not be achievable by all the video codecs. Therefore, in various embodiments, ensuring that decoded data corresponding to different submeshes can be separated to allow for independent reconstruction of subdivided submeshes can be supported as described above.

However, in some embodiments, a bitstream conformance can be imposed that requires that it shall be possible to decode geometry data and attributes data and reconstruct vertices, connectivity, and attributes corresponding to a submesh independently of other submeshes. In some embodiments, the decoded geometry data corresponds to displacements associated with a submesh. In some embodiments, since some of video codecs may not include functionality to have independently decodable slices, tiles or subpictures, it may not be mandated that the displacement and attribute data corresponding to different submeshes be placed in independently decodable tiles or subpictures. Instead, flags can be used to indicate partial decoding functionality as follows.

Consider a dynamic mesh bitstream that contains multiple submeshes and that has an attribute sub-bitstream. In various embodiments, a flag can be used to indicate whether each dependently decodable unit of the attribute video sub-bitstream contains data corresponding to one and only one submesh. A value of 1 for the flag provides an indication to the decoder that partial decoding and reconstruction of submeshes is possible. In some embodiments, a flag, e.g., “one_submesh_per_independent_unit_attribute_flag” is included in submesh information, e.g., “bmesh_sub_mesh_information( )” to indicate partial decoding functionality of the attributes sub-bitstream. A value of 1 for the flag indicates that each independently decodable unit in the attribute sub-bitstream includes coded data from at most one submesh. A flag value of 0 indicates that each independently decodable unit in the attribute sub-bitstream may include coded data corresponding to multiple submeshes.

In some embodiments, the semantics for the flag value of 1 can indicate that each independently decodable unit in the attribute sub-bitstream includes coded data corresponding to exactly one submesh. This disallows independently decodable units that do not include coded data from a submesh. In some embodiments, the semantics for the flag value of 0 can indicate that at least one independently decodable unit in the attribute sub-bitstream includes coded data corresponding to multiple submeshes.

In various embodiments, similar flags as described above can be signaled for the displacement sub-bitstream that includes coded data for displacement fields. For instance, a flag, e.g., “one_submesh_per_independent_unit_geometry_flag” is included in submesh information, e.g., “bmesh_sub_mesh_information( )” to indicate partial decoding functionality of the displacement sub-bitstream. A flag value of 1 indicates that each independently decodable unit in the displacement sub-bitstream includes coded data from at most one submesh. A flag value of 0 indicates that each independently decodable unit in the displacement sub-bitstream may include coded data corresponding to multiple submeshes.

In some embodiments, the semantics for a flag value of 1 for the displacement sub-bitstream can indicate that each independently decodable unit in the displacement sub-bitstream includes coded data corresponding to exactly one submesh. In some embodiments, the semantics for flag value of 0 can indicate that at least one independently decodable unit in the displacement sub-bitstream includes coded data corresponding to multiple submeshes.

Various standards have been proposed with respect to vertex mesh and dynamic mesh coding. The following documents are hereby incorporated by reference in their entirety as if fully set forth herein:
“V-Mesh Test Model v1,” ISO/IEC SC29 WG07 N00404, July 2022;
“V-DMC Test Model v2 (TMM v2),” ISO/IEC SC29 WG07 N00456, October 2022;
“WD 1.0 of V-DMC,” ISO/IEC SC29 WG07, N00486, December 2022;
“WD 2.0 of V-DMC,” ISO/IEC SC29 WG07 N00546, January 2023;
“WD 3.0 of V-DMC,” ISO/IEC SC29 WG07 N00611, April 2023;
“WD 4.0 of V-DMC,” ISO/IEC JTC 1/SC 29/WG 07 N00611, August 2023; and
“WD 5.0 of V-DMC,” ISO/IEC JTC 1/SC 29/WG 7 N00744, August 2023.

To provide the partial reconstruction and/or partial decoding of submeshes according to this disclosure, the standards can be updated to specify the syntax for the flags in WD 1.0 of V-DMC as follows.

### H.8.1.3.2.2 Basemesh Submesh Information

| basemesh_submesh_information( ) { | Descriptor |
|---|---|
| bsmi_use_single_mesh_flag | u(1) |
| if(!bsmi_use_single_mesh_flag){ | |
| bsmi_num_submeshes_minus1 | u(8) |
| one_submesh_per_independent_unit_geometry_flag | u(1) |
| one_submesh_per_independent_unit_attribute_flag | u(1) |
| } | |
| Else | |
| bsmi_num_submeshes_minus1 = 0 | |
| ... | |
| } | |

Various embodiments can use the semantics as described above.

Although in some embodiments, signaling of the flags can be within the “basemesh_submesh_information( )”, in some embodiments the flags can be signaled as part of Volumetric Visibility Information, in some embodiments as part of a Supplemental Enhancement Information (SEI) message, or in other syntax structures. In some embodiments, if a video bitstream includes a hierarchy of independently decodable units, the flag can be interpreted as applicable to the independently decodable unit at the lowest level, i.e., the smallest size.

Although FIG. 6 illustrates one example process 600 for bitstream conformance for partial reconstruction and/or decoding of submeshes, various changes may be made to FIG. 6. The 600 may be used in any other suitable process and is not limited to the specific process described above. Also, while shown as a series of steps, various steps in FIG. 6 may overlap, occur in parallel, or occur any number of times.

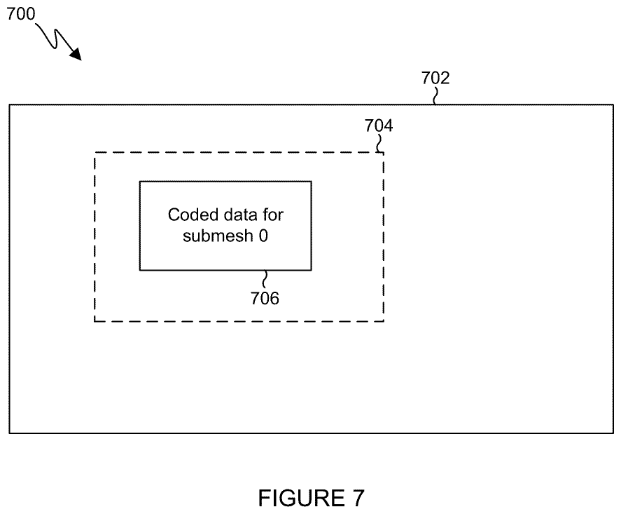

FIG. 7 illustrates an example process 700 for bounding coordinates associated with a sub-bitstream in accordance with this disclosure. The process 700 illustrated in FIG. 7 is for illustration only. FIG. 7 does not limit the scope of this disclosure to any particular implementation of a process for bounding coordinates associated with a sub-bitstream. For ease of explanation, the process 700 of FIG. 7 may be described as being performed using the electronic device 300 of FIG. 3. However, the process 700 may be used with any other suitable system and any other suitable electronic device.

It can also be useful to have information concerning which independently decodable units from the sub-bitstreams are associated with each submesh, irrespective of whether the corresponding independently decodable unit flag described above is 0 or 1. Since it is possible to choose from many video codecs such as AVC, HEVC, and VVC, each codec may have a different way of signaling the independently decodable unit identifier. To account for this, in some embodiments, a bounding rectangle or box 704 can be signaled with respect to the 2D coordinates associated with that specific video sub-bitstream 702.

For example, for an attribute sub-bitstream corresponding to attribute j and atlas i, four syntax elements may be signaled for each submesh. To provide this information, the standards can be updated to specify the following in V-DMC WD 1.0 (for illustrative purposes, the indexing with respect to atlas and attribute identifier is not shown):

### H.8.1.3.2.2 Basemesh Submesh Information

| bmesh_sub_mesh_information( ) { | Descriptor |
|---|---|
| ... | u(1) |
| bsmi_signalled_submesh_id_flag | u(1) |
| if( bsmi_signalled_submesh_id_flag ) { | |
| bmsi_signalled_submesh_id_length_minus1 | ue(v) |
| for( i = 0; i < bmsi_signalled_submesh_id_length_ | |
| minus1 + 1; i++) | |
| bmsi_submesh_id[ i ] | u(v) |
| SubMeshIDToIndex[ bmsi_submesh_id[ i ] ] = i | |
| SubMeshIndexToID[ i ] = bmsi_submesh_id[ i ] | |
| } | |
| } | |
| Else | |
| for( i = 0; i < bsmi_num_submeshes_minus1 + 1; | |
| i++ ) { | |
| bmsi_submesh_id[ i ] = i | |
| SubMeshIDToIndex[ i ] = i | |
| SubMeshIndexToID[ i ] = i | |
| } | |
| for( i = 0; i < bsmi_num_submeshes_minus1 + 1; i++ ) { | |
| submeshIdx = bmsi_submesh_id[ i ] | |
| submesh_attribute_2d_pos_x[ submeshIdx ] | ue(v) |
| submesh_attribute_2d_pos_y[ submeshIdx ] | ue(v) |
| submesh_attribute_2d_size_x_minus1[ submeshIdx ] | ue(v) |
| submesh_attribute_2d_size_y_minus1[ submeshIdx ] | ue(v) |
| } | |
| } | |

The “submesh_attribute_2d_pos_x[submeshIdx]” shown above can specify the x-coordinate of the top-left corner of the submesh bounding box 704 with respect to the attribute video for the current submesh with ID submeshIdx. The “submesh_attribute_2d_pos_y[submeshIdx]” shown above can specify the y-coordinate of the top-left corner of the submesh bounding box 704 with respect to the attribute video for the current submesh with ID submeshIdx. The “submesh_attribute_2d_size_x_minus1 [submeshIdx]” shown above plus 1 can specify the width value of the submesh bounding box 704 with respect to the attribute video for the current submesh with ID submeshIdx. The “submesh_attribute_2d_size_y_minus1[submeshIdx]” shown above plus 1 can specify the height value of the submesh bounding box 704 with respect to the attribute video for the current submesh with ID submeshIdx.

In some embodiments, the position and size of the submesh bounding box 704 can be specified in terms of number of pixels with respect to the attributes sub-bitstream. In some embodiments, the position and size of the submesh bounding box 704 can be specified in terms of a multiple of an integer. In one embodiment, the integer may be the “PatchPackingBlockSize” element. In some embodiments, instead of ue(v), the syntax elements may be signaled using a fixed length, such as 16 bits or a fixed length that is signaled in the bitstream.

In some embodiments, it can be a requirement of bitstream conformance that all the pixels inside the bounding box specified by the syntax elements “submesh_attribute_2d_pos_x,” “submesh_attribute_2d_pos_y,” “submesh_attribute_2d_size_x_minus1,” and “submesh_attribute_2d_size_x_minus1” are inside the attribute sub-bitstream. However, it will be understood that, additionally or alternatively, similar positioning data for a similar bounding box or boxes can be singled for displacement data to identify independently decodable units corresponding to a submesh in the displacement sub-bitstream.

Assuming the bitstream conformance requirement imposed above, i.e., that it shall be possible to reconstruct vertices, connectivity, and attribute data corresponding to a submesh independently of the decoded data corresponding to other submeshes, in that case, in some embodiments another bitstream conformance requirement can be introduced to provide a tight bounding box that includes coded data for a single submesh, such as the tight bounding box 706 shown in FIG. 7. For example, a tight bounding box corresponding to a submesh can be defined as the smallest rectangle (in term of width and height) that includes all the 2D positions in the attribute (or displacements) sub-bitstream that includes the coded data corresponding to the submesh. Thus, as shown in FIG. 7, while in some embodiments the bounding box 704 can be used to designate 2D coordinates in which coded data corresponding to a submesh is retained, the tight bounding box 706 can be used to define a smaller area in the sub-bitstream 702 that includes the coded data corresponding to the submesh. Thus, in some embodiments, it can be a requirement of bitstream conformance that the bounding box signaled by the syntax elements “submesh_attribute_2d_pos_x,” “submesh_attribute_2d_pos_y,” “submesh_attribute_2d_size_x_minus1,” and “submesh_attribute_2d_size_x_minus1” is tight like the tight bounding box 706, for example.

Although FIG. 7 illustrates one example process 700 for bounding coordinates associated with a sub-bitstream, various changes may be made to FIG. 7. For example, the number and placement of various components of the process 700 can vary as needed or desired. In addition, the process 700 may be used in any other suitable process and is not limited to the specific process described above.

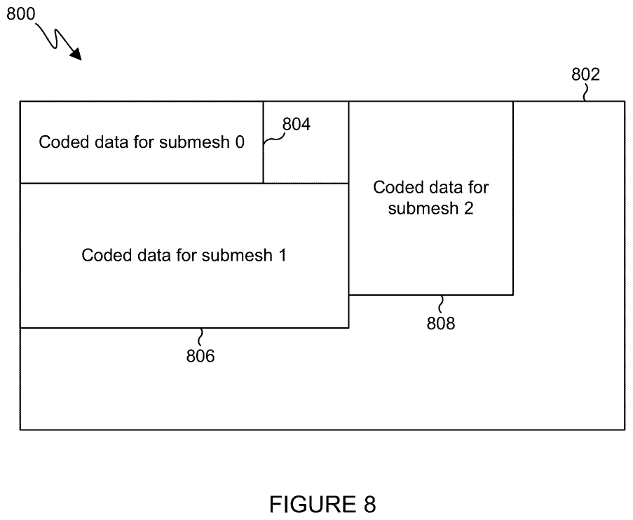

FIG. 8 illustrates an example process 800 for bounding coordinates associated with a sub-bitstream in a non-overlapping manner in accordance with this disclosure. The process 800 illustrated in FIG. 8 is for illustration only. FIG. 8 does not limit the scope of this disclosure to any particular implementation of a process for bounding coordinates associated with a sub-bitstream in a non-overlapping manner. For ease of explanation, the process 800 of FIG. 8 may be described as being performed using the electronic device 300 of FIG. 3. However, the process 800 may be used with any other suitable system and any other suitable electronic device.

In some embodiments, it can be a requirement of bitstream conformance that signaled bounding boxes corresponding to different submeshes, such as described with respect to FIG. 7, are non-overlapping. For purposes of illustration, FIG. 8 shows a sub-bitstream 802 having a first bounding box 804, a second bounding box 806, and a third bounding box 808. The first bounding box 804 includes data corresponding to a first submesh, the second bounding box 806 includes data corresponding to a second submesh, and the third bounding box 808 includes data corresponding to a third submesh. As shown in FIG. 8, the first bounding box 804, the second bounding box 806, and the third bounding box 808 are defined such that the bounding boxes do not overlap, in order to prevent data for other submeshes (i.e., more than one submesh) to be within a single bounding box.

In some embodiments, it can a requirement of bitstream conformance that the signaled bounding boxes corresponding to different submeshes are tight and non-overlapping. For example, a tight bounding box such as the tight bounding box 706 described with respect to FIG. 7 can be used for the first bounding box 804, the second bounding box 806, and the third bounding box 808, such that the bounding boxes are all tight and non-overlapping.

If the above condition regarding non-overlap of tight bounding boxes corresponding to different submeshes is not imposed, then sometimes one part of a submesh may be placed in one corner and another part of the submesh may be placed in another corner, for instance. In such cases, a single bounding box will result in an overlap with a large number of independently decodable units that have no coded data corresponding to the submesh. To avoid this, in some embodiments, for each submesh, multiple bounding boxes may be signaled. This may be accomplished by signaling the number of bounding boxes minus 1. This may be followed by signaling the top-left position and size of the bounding box for each bounding box, similar to that described above in this disclosure. In some embodiments, multiple bounding boxes may be signaled for each submesh with respect to the attribute sub-bitstream and the displacement sub-bitstream separately.

In some embodiments, a video decoder for the attribute sub-bitstream may use the bounding box information to derive which independently decodable units need to be decoded for each submesh and decode only those units to achieve partial decoding. In some embodiments, similar bounding boxes corresponding to each submesh may be signaled for the displacement sub-bitstream containing the displacement field. In some embodiments, a video decoder for the displacement sub-bitstream may use the bounding box information to derive which independently decodable units need to be decoded for each submesh and decode only those units to achieve partial decoding. In some embodiments, instead of signaling the bounding boxes, the number of independently decodable units containing data corresponding to that submesh may be signaled for each submesh, followed by the identifiers (IDs) of those units. This may be a tile ID, a slice ID, or a sub-picture ID, for example.

In some embodiments, a combination of volumetric annotation SEI message family syntax may be used to achieve similar functionality. As an example, each submesh may be assigned to a scene object and a combination of a scene object information SEI message and a volumetric rectangle information SEI message may be used to send information about the bounding boxes. One advantage of this approach is that the position of the bounding box may be updated within a sequence. In such cases, the scene object information SEI message can be modified to be able to associate the scene object with a specific submesh. Similarly, the scene object information SEI message or the volumetric rectangle information SEI message may be modified to include information on whether the rectangles refer to an attribute sub-bitstream or a displacement sub-bitstream.

Although FIG. 8 illustrates one example process 800 for bounding coordinates associated with a sub-bitstream in a non-overlapping manner, various changes may be made to FIG. 8. For example, the number and placement of various components of the process 800 can vary as needed or desired. For instance, although three bounding boxes are shown in FIG. 8, any number of bounding boxes could be used, such as depending on how many submeshes there are for the bitstream. In addition, the process 800 may be used in any other suitable process and is not limited to the specific process described above.

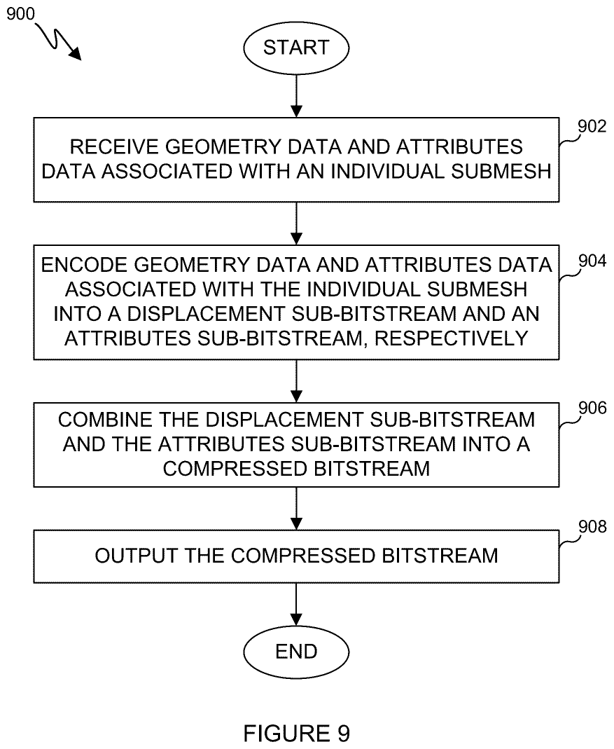

FIG. 9 illustrates an example encoding method 900 for partial reconstruction and/or decoding of submeshes in accordance with this disclosure. For ease of explanation, the method 900 of FIG. 9 is described as being performed using the electronic device 300 of FIG. 3. However, the method 900 may be used with any other suitable system and any other suitable electronic device.

As shown in FIG. 9, at step 902, the electronic device 300 receives geometry data and attributes data associated with an individual submesh. In some embodiments, the geometry data corresponds to displacements created based on subdividing one or more submeshes. At step 904, the electronic device 300 encodes the geometry data and the attributes data associated with the individual submesh into a displacement sub-bitstream and an attributes sub-bitstream, respectively, such as described with respect to FIG. 4. In various embodiments, bitstream conformance requirements can be imposed, such as described with respect to FIG. 6, such that the geometry data and attributes data associated with the individual submesh are capable of being separated from data corresponding to one or more other submeshes in the displacement sub-bitstream and the attributes sub-bitstream during decoding.

At step 906, the electronic device combines the displacement sub-bitstream and the attributes sub-bitstream into a compressed bitstream, as also described with respect to FIG. 4. In some embodiments, during the encoding, the electronic device 300 can set one or more flags in the compressed bitstream indicating whether or not each independently decodable unit of at least one of the displacement sub-bitstream and the attributes sub-bitstream includes data corresponding to (i) one and only one submesh or (ii) at most one submesh, as also described with respect to FIG. 6. In some embodiments, the one or more flags are signaled as part of Volumetric Visibility Information or as part of a Supplemental Enhancement Information (SEI) message.

In some embodiments, during the encoding, the electronic device 300 can signal a bounding box associated with the individual submesh, the bounding box corresponding to two-dimensional (2D) coordinates of at least one of the displacement sub-bitstream and the attributes sub-bitstream, as described with respect to FIGS. 7 and 8. In various embodiments, the electronic device 300 can form the bounding box to be at least one of (i) in a smallest possible area while still including all 2D positions that contain coded data corresponding to the individual submesh and (ii) non-overlapping with one or more other bounding boxes associated with one or more other submeshes.

In some embodiments, during encoding, the electronic device 300 can include a signaling element indicating a number of independently decodable units of at least one of the displacement sub-bitstream and the attributes sub-bitstream corresponding to the subdivided submesh, and an identifier for each of the independently decodable units. That is, the number of independently decodable units containing data corresponding to a submesh may be signaled for each submesh, followed by the IDs of those units, which may be a tile ID, a slice ID, or a sub-picture ID, for example.

During encoding, to provide that decoded data pertaining to a particular submesh can be separated from other data during decoding, the electronic device 300 can apply a forward wavelet transform, e.g., wavelet transform 410, to a displacement field such that geometry data including displacements from other submeshes are excluded when the forward wavelet transform is applied. That is, the forward wavelet transform is applied independently to each submesh.

At step 908, the electronic device 300 outputs the compressed bitstream. This output bitstream can also include the compressed base mesh bitstream, and the atlas sub-bitstream described, for example, with respect to FIG. 4, as well as any of the signaling elements described above. The output bitstream can be transmitted to an external device or to a storage on the electronic device 300.

Although FIG. 9 illustrates one example of an encoding method 900 for partial reconstruction and/or decoding of submeshes, various changes may be made to FIG. 9. For example, while shown as a series of steps, various steps in FIG. 9 may overlap, occur in parallel, or occur any number of times.

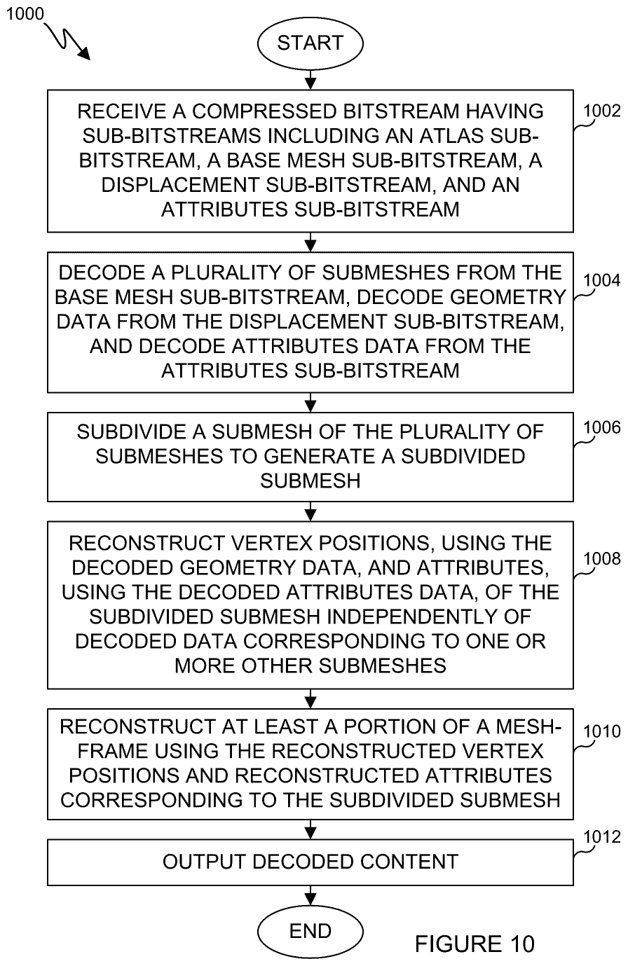

FIG. 10 illustrates an example decoding method 1000 for partial reconstruction and/or decoding of submeshes in accordance with this disclosure. For ease of explanation, the method 1000 of FIG. 10 is described as being performed using the electronic device 300 of FIG. 3. However, the method 1000 may be used with any other suitable system and any other suitable electronic device.

As shown in FIG. 10, at step 1002, the electronic device 300 receives a compressed bitstream having sub-bitstreams including a base mesh sub-bitstream, a displacement sub-bitstream, and an attributes sub-bitstream. In some embodiments, the compressed bitstream can also include an atlas sub-bitstream. At step 1004, the electronic device decodes at least a portion of the compressed bitstream, which can include the electronic device decoding a plurality of submeshes from the base mesh sub-bitstream, decoding geometry data from the displacement sub-bitstream, and decoding attributes data from the attributes sub-bitstream, as also described with respect to FIG. 5.

In some embodiments, to decode the at least a portion of the compressed bitstream, the electronic device 300 decodes the geometry data and attributes of the subdivided submesh independently from coded data associated with the one or more other submeshes included in the compressed bitstream, as also described with respect to FIG. 6. This can include, in some embodiments, the electronic device 300 identifying one or more flags in the compressed bitstream indicating whether or not each independently decodable unit of at least one of the displacement sub-bitstream and the attributes sub-bitstream includes data corresponding to (i) one and only one submesh or (ii) at most one submesh. In some embodiments, the one or more flags are signaled as part of Volumetric Visibility Information or as part of a Supplemental Enhancement Information (SEI) message.

In some embodiments, the electronic device 300 can decode a bounding box associated with the subdivided submesh signaled by an encoder, where the bounding box corresponds to two-dimensional (2D) coordinates of at least one of the displacement sub-bitstream and the attributes sub-bitstream, as described with respect to FIGS. 7 and 8. In some embodiments, the bounding box occupies a smallest possible area while still including all 2D positions that contain coded data corresponding to the submesh.

In some embodiments, the electronic device 300 can identify from a signaling element a number of independently decodable units of at least one of the displacement sub-bitstream and the attributes sub-bitstream corresponding to the subdivided submesh, and an identifier for each of the independently decodable units. That is, the number of independently decodable units containing data corresponding to a submesh may be signaled for each submesh, followed by the IDs of those units, which may be a tile ID, a slice ID, or a sub-picture ID, for example.

At step 1006, the electronic device subdivides a submesh of the plurality of submeshes to generate a subdivided submesh. At step 1008, the electronic device reconstructs at least vertex positions, using the decoded geometry data, and attributes, using the decoded attributes data, of the subdivided submesh independently of decoded data corresponding to one or more other submeshes, as also described with respect to FIG. 6. The decoded geometry data can be from independently decodable units for signaled IDs corresponding to that submesh. This can include the electronic device 300 using an inverse wavelet transform on the decoded geometry data corresponding to the submesh to obtain displacements associated with the subdivided submesh independently from the decoded geometry data corresponding to the one or more other submeshes.

At step 1010, the electronic device reconstructs at least a portion of a mesh-frame using the reconstructed vertex positions and reconstructed attributes corresponding to the subdivided submesh. At step 1012, the electronic device 300 outputs the decoded content, such as 3D video including a reconstructed mesh-frame. The output decoded content can be transmitted to an external device or to a storage on the electronic device 300, for instance.

Although FIG. 10 illustrates one example of a decoding method 1000 for partial reconstruction and/or decoding of submeshes, various changes may be made to FIG. 10. For example, while shown as a series of steps, various steps in FIG. 10 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a communication interface configured to receive a compressed bitstream having sub-bitstreams including a base mesh sub-bitstream, a displacement sub-bitstream, and an attributes sub-bitstream; and
a processor operably coupled to the communication interface, the processor configured to:
decode at least a portion of the compressed bitstream, wherein the processor is configured to decode a plurality of submeshes from the base mesh sub-bitstream, decode geometry data from the displacement sub-bitstream, and decode attributes data from the attributes sub-bitstream;
subdivide a submesh of the plurality of submeshes to generate a subdivided submesh;
reconstruct vertex positions, using the decoded geometry data, and attributes, using the decoded attributes data, of the subdivided submesh independently of decoded data corresponding to one or more other submeshes; and
reconstruct at least a portion of a mesh-frame using the reconstructed vertex positions and reconstructed attributes corresponding to the subdivided submesh.

2. The apparatus of claim 1, wherein the processor is further configured to use an inverse wavelet transform on the decoded geometry data corresponding to the submesh to obtain displacements associated with the subdivided submesh independently from the decoded geometry data corresponding to the one or more other submeshes.

3. The apparatus of claim 1, wherein, to decode the at least a portion of the compressed bitstream, the processor is further configured to decode the geometry data and attributes of the subdivided submesh independently from coded data associated with the one or more other submeshes included in the compressed bitstream.

4. The apparatus of claim 3, wherein the processor is further configured to identify one or more flags in the compressed bitstream indicating whether or not each independently decodable unit of at least one of the displacement sub-bitstream and the attributes sub-bitstream includes data corresponding to (i) one and only one submesh or (ii) at most one submesh.

5. The apparatus of claim 4, wherein the one or more flags are signaled as part of Volumetric Visibility Information or as part of a Supplemental Enhancement Information (SEI) message.

6. The apparatus of claim 1, wherein the processor is further configured to decode a bounding box associated with the subdivided submesh signaled by an encoder, the bounding box corresponding to two-dimensional (2D) coordinates of at least one of the displacement sub-bitstream and the attributes sub-bitstream.

7. The apparatus of claim 6, wherein the bounding box occupies a smallest possible area while still including all 2D positions that contain coded data corresponding to the submesh.

8. The apparatus of claim 1, wherein the processor is further configured to identify from a signaling element a number of independently decodable units of at least one of the displacement sub-bitstream and the attributes sub-bitstream corresponding to the subdivided submesh, and an identifier for each of the independently decodable units.

9. A method comprising:
receiving a compressed bitstream having sub-bitstreams including a base mesh sub-bitstream, a displacement sub-bitstream, and an attributes sub-bitstream;
decoding at least a portion of the compressed bitstream, including decoding a plurality of submeshes from the base mesh sub-bitstream, decoding geometry data from the displacement sub-bitstream, and decoding attributes data from the attributes sub-bitstream;
subdividing a submesh of the plurality of submeshes to generate a subdivided submesh;
reconstructing vertex positions, using the decoded geometry data, and attributes, using the decoded attributes data, of the subdivided submesh independently of decoded data corresponding to one or more other submeshes; and
reconstructing at least a portion of a mesh-frame using the reconstructed vertex positions and reconstructed attributes corresponding to the subdivided submesh.

10. The method of claim 9, further comprising using an inverse wavelet transform on the decoded geometry data corresponding to the submesh to obtain displacements associated with the subdivided submesh independently from the decoded geometry data corresponding to the one or more other submeshes.

11. The method of claim 9, wherein decoding the at least a portion of the compressed bitstream includes decoding the geometry data and attributes of the subdivided submesh independently from coded data associated with the one or more other submeshes included in the compressed bitstream.

12. The method of claim 11, further comprising identifying one or more flags in the compressed bitstream indicating whether or not each independently decodable unit of at least one of the displacement sub-bitstream and the attributes sub-bitstream includes data corresponding to (i) one and only one submesh or (ii) at most one submesh.

13. The method of claim 12, wherein the one or more flags are signaled as part of Volumetric Visibility Information or as part of a Supplemental Enhancement Information (SEI) message.

14. The method of claim 9, further comprising decoding a bounding box associated with the subdivided submesh signaled by an encoder, the bounding box corresponding to two-dimensional (2D) coordinates of at least one of the displacement sub-bitstream and the attributes sub-bitstream.

15. The method of claim 14, wherein the bounding box occupies a smallest possible area while still including all 2D positions that contain coded data corresponding to the submesh.

16. The method of claim 9, further comprising identifying from a signaling element a number of independently decodable units of at least one of the displacement sub-bitstream and the attributes sub-bitstream corresponding to the subdivided submesh, and an identifier for each of the independently decodable units.

17. An apparatus comprising:
a communication interface; and
a processor operably coupled to the communication interface, the processor configured to:
encode geometry data and attributes data associated with an individual submesh into a displacement sub-bitstream and an attributes sub-bitstream, respectively,
wherein the geometry data and attributes data associated with the individual submesh are capable of being separated from data corresponding to one or more other submeshes in the displacement sub-bitstream and the attributes sub-bitstream during decoding; and
combine the displacement sub-bitstream and the attributes sub-bitstream into a compressed bitstream.

18. The apparatus of claim 17, wherein the processor is further configured to set one or more flags in the compressed bitstream indicating whether or not each independently decodable unit of at least one of the displacement sub-bitstream and the attributes sub-bitstream includes data corresponding to (i) one and only one submesh or (ii) at most one submesh.

19. The apparatus of claim 17, wherein the processor is further configured to signal a bounding box associated with the individual submesh, the bounding box corresponding to two-dimensional (2D) coordinates of at least one of the displacement sub-bitstream and the attributes sub-bitstream.

20. The apparatus of claim 19, wherein the processor is further configured to form the bounding box to be at least one of:
in a smallest possible area while still including all 2D positions that contain coded data corresponding to the individual submesh; and
non-overlapping with one or more other bounding boxes associated with one or more other submeshes.
